(19) United States
(12) Patent Application Publication
(10) Pub. No.: US 2026/0357375 A1
(43) Pub. Date: Nov. 12, 2026

(54) PROCESS FOR PREPARING CEMENTED CARBIDE SCRAP FOR RECYCLING

(71) Applicant: WOLFRAM BERGBAU UND HÜTTEN AG, St. Martin im Sulmtal (AT)

(72) Inventors: Thomas ZIMMERL, St. Martin im Sulmtal (AT); Raphael ROYER, Hanau (DE)

(21) Appl. No.: 19/139,779

(22) PCT Filed: Dec. 18, 2023
(86) PCT No.: PCT/EP2023/086264

§ 371 Date: Jun. 16, 2025

(30) Foreign Application Priority Data
Dec. 20, 2022 (EP) 22215109.4

(51) Int. Cl. C22B 7/00; C22B 1/00

(52) U.S. Cl. CPC C22B 7/007; C22B 1/005

(57) ABSTRACT

A method of preparing cemented carbide scrap for recycling by removing any residues and/or coatings from the cemented carbide scrap is provided. The process involves subjecting the cemented carbide scrap to an acid treatment followed by removal of any residues and/or coatings by mechanical means. The removal of residues and/or coatings limits the amount of unwanted particles and elements that can impact the quality of the recycled powder and also the quality of the cemented carbide made therefrom.

The present invention relates to a method of preparing cemented carbide scrap for recycling. The process involves cleaning and/or removal of any coating prior to subjecting the scrap to a recycling step without creating additional waste.

### BACKGROUND

Recycling of cemented carbides has been known for a long time and several processes for recycling are used in the art such as direct or indirect recycling methods. The recycled material obtained from such processes are then, at least partly, replacing virgin materials when making cemented carbide products all over again. Usually, in recent years, the fraction of recycled material in production of cemented carbide has, in recent years, increased and certain elements can be accumulated over time in the recycled material when recycling the cemented carbide repeatedly.

Cemented carbide can be used in many different applications, in mining tools, as wear parts, rolls and in cutting tools such as inserts, drills, end mills etc. It is common in the art to provide cutting tools with a wear resistant coating to increase the tool life. Typical coatings are CVD coatings like e.g. TiCN, Al₂O₃ and PVD coatings e.g. nitrides of Si, Ti, Cr, Al etc.

If not removed during recycling, some of the elements originating from the coatings and/or residues like e.g. brazing residues can cause defects in the microstructure of the cemented carbide if the amounts are too high. With the increasing fraction of recycled carbide in cemented carbide manufacturing the elements originating from the coating and other residues will accumulate over time or will lower the quality of the cemented carbides.

There have been several attempts to remove the coating from cutting tools. Many of those methods are based on the idea to chemically dissolve the coating. For drills there are methods that can remove the coating without damaging the cemented carbide beneath. This is beneficial when the drills are to be reconditioned i.e. regrinded and coated. See e.g. US20110056914. However, those methods are usually involving chemicals that are both expensive and difficult to handle.

Mechanical removal of residues and/or coatings can also be used, however, the removal rate is not sufficient to meet the increasing demands of avoiding accumulation of the elements from the coatings and the negative effect on the product.

Cemented carbide scrap can also contain other unwanted elements or residues that is preferably removed before any recycling step, such as rock residues in mining tools, solders, brazing residues etc. Such unwanted residues can lower the quality of the powder and also the final product.

It is an object of the present invention to obtain a method of removing the coating from coated cemented carbide scrap with a high removal rate.

It is an object of the present invention to obtain a method of removing residues and/or coatings from cemented carbide scrap where the remaining cemented carbide scrap is recycled.

It is an object of the present invention to obtain a method of removing residues and/or coatings from cemented carbide scrap that is time efficient and where the chemicals are easy to handle.

It is an object of the present invention to obtain a method of removing the residues and/or coatings from cemented carbide scrap where both the cemented carbide and the removed material can be recirculated in a sustainable way.

### DETAILED DESCRIPTION OF THE PRESENT INVENTION

The present invention relates to a method of removing residues and/or coating from cemented carbide scrap comprising the steps of:
subjecting the cemented carbide scrap to an acid treatment in an acid solution having a concentration of between 0.2 and 10 N, for a time period of between 30 minutes and 72 hours, at a temperature of between 15 and 99 °C,
removing the residues and/or coating by mechanical means.

The acid used in the acid solution can be any acid that is able to dissolve the metal binder under the residues and/or coating, preferably the acid is one or more of sulfuric acid (H₂SO₄), chloric acid (HCl), acetic acid (CH₃COOH) or phosphorus acid (H₃PO₃), more preferably one or more of sulfuric acid (H₂SO₄) and hydrochloric acid (HCl), most preferably sulfuric acid (H₂SO₄).

When the cemented carbide scrap contains brazing residues like e.g. solder, the solder can also, at least partly, be dissolved in the acid.

The concentration (Normality) of the acid solution is between 0.2 and 10 N, preferably between 0.3 and 6 N, more preferably between 0.5 and 3 N.

The temperature of the acid solution can be between 15 and 99 °C, preferably between 50 and 90 °C.

The time that the cemented carbide is subjected to the acid treatment is between 30 minutes and 72 hours, preferably between 10 and 48 hours. The time is dependent on the concentration of the acid solution and the temperature.

In one embodiment of the present invention, the acid treatment is performed without any applied pressure or electric current.

The cemented carbide pieces are preferably washed after the acid treatment to remove any remaining acid. This is mainly done to avoid corrosion of the equipment.

After the acid treatment, any residue and/or coating will still be present but with poor adhesion since the acid treatment has dissolved the metal binder in the outermost part of the cemented carbide and the residue and/or coating can thus be removed more easily. A coating will thus not necessarily be affected by the acid treatment itself, instead, the adhesion to the underlaying cemented carbide substrate will be impaired due to the dissolution of the metal binder.

After the acid treatment, the residues and/or coating is removed from the cemented carbide scrap by mechanical means. By mechanical means is herein meant any type of mechanical treatment that can remove the residue and/or coating. Preferably the residues and/or coating is removed by blasting or tumbling. Following the mechanical treatment, the removed residues and/or coating residues are separated from the cemented carbide scrap by any suitable means like e.g. sieving, magnetic means etc.

In one embodiment of the present invention, after the acid treatment, the residues and/or coating is removed from the cemented carbide scrap by blasting. Blasting can be used on all types of cemented carbide scrap but is especially useful for drills and end mills that are provided with flutes. If a coating is present in the flutes it can be difficult to reach with other types of mechanical removal methods. The exact parameters of the blasting step, i.e. type of blasting media, blasting pressure, wet or dry blasting, nozzle size etc. can depend on several things for example the type of blasting equipment used and it is up the person skilled in the art to adjust the parameters so that the desired result is achieved.

In one embodiment of the present invention, after the acid treatment, the residues and/or coating is removed from the cemented carbide scrap by tumbling. The most common type of tumbling is where pieces are placed in a rotating drum and where the pieces are allowed to collide against each other and against the walls of the drum. Tumbling is specifically suitable when larger volumes of cemented carbide scrap is to be treated. The parameters for the tumbling process such as load of the drum, rotational speed etc. is set by a person skilled in the art depending on type and size of drum, size of the cemented carbide scrap etc.

By cemented carbide scrap is herein meant solid cemented carbide pieces in the shape of cutting inserts, drills, end mills, mining buttons, rolls etc.

By cemented carbide is herein meant a sintered material comprising grains of a hard phase embedded in a metallic binder where the hard phase comprises at least 50 wt % WC. Other hard phase constituents that can be present is carbides, nitrides or carbonitrides of one or more of Nb, Ti, Ta, Cr, V etc.

The metallic binder can be any metallic binder used in the art of cemented carbides, e.g. one of Fe, Co and Ni or alloys thereof. The most commonly used binder is Co.

The most common type of cemented carbide scrap having a coating is cutting tools such as inserts, drills, end mills etc. The coating to be removed can be any coating used on cemented carbides. Typical coatings are those deposited using conventional PVD (physical vapor deposition) and CVD (chemical vapor deposition). Recently, also more advanced deposition techniques have become more common like e.g. HIPIMS (high power impulse magnetron sputtering) which is a PVD technique.

Cutting tools such as inserts are commonly deposited with either PVD or CVD technique, whereas cutting tools such as drills or endmills are usually coated using PVD technique.

By residues are herein meant any unwanted particles or elements that is not part of the cemented carbide substrate or coating. These residues are beneficial to be removed from the cemented carbide scrap prior to recycling of the cemented carbide. Examples of residues are brazing residues, rock residues, residues of work piece material welded to a cutting tool during machining operations etc.

Mining tools and wear parts of cemented carbide are usually brazed with a solder to a holder, drill head etc. Before being recycled, the cemented carbide part is separated from the holder and some of the solder can still remain as brazing residues on the cemented carbide part. Mining tools can also contain parts of rock that are wedged into the mining tool during operation. Cutting tools can also contain brazed parts which can leave braze residues.

In one embodiment of the present invention, the cemented carbide scrap is subjected to a mechanical pre-treatment prior to the acid treatment. The mechanical pre-treatment can be any technique that can cause defects like e.g. cracks in a coating or even crush the cemented carbide scrap into smaller pieces. Examples of such techniques are tumbling, blasting and crushing. Causing defects or crushing the scrap can make it easier for the acid in the acid treatment to penetrate the coating in order to dissolve the metal binder. This step can be beneficial if the coating thickness is too large and/or if the coating is of a type that is very dense like e.g. HIPIMS coatings etc.

### Example 1 (Invention)

A batch of coated inserts were subjected to an acid treatment in 12 wt % H2SO4 at 70 °C for 24 h. After the acid treatment the inserts were washed with water and 1500 g of the inserts were subjected to a tumbling process by placing the inserts in an 800 ml mill and the mill was filled up to ⅔ with water. The mill was then run for 36 h.

After the tumbling, the cemented carbide scrap and the fine coating residue was separated through a sieve (1 mm).

When comparing the cemented carbide scrap before and after the decoating process, a removal of more than 70% of the coating could be concluded by visual inspection.

### Example 2 (Invention)

13.75 tons of coated inserts were treated for 24 h in 12 wt. % H2SO4 at 80 °C. After the acid treatment the inserts were washed and the inserts were subjected to a tumbling process using a large mill (1 ton). The mill was then run for 36 h.

After the tumbling, the cemented carbide scrap and the fine coating residue was separated through a sieve (3 mm).

When comparing the cemented carbide scrap before and after the decoating process, a removal of more than 70% of the coating could be concluded by visual inspection.

### Example 3 (Comparative)

A batch of coated inserts were subjected to a tumbling process in water for 36 hours. The inserts were washed and when investigated, more than 60% of the coating still remaining after visual inspection.

The inserts were then subjected to a recycling process (Zn process) in order to be form a recycled cemented carbide powder. When analyzing the recycled cemented carbide powder, coating flakes and coating residues could be detected when looking at the powder in a microscope.

### Example 4

Drills and endmills coated with a PVD coating were prepared.

One batch was subjected to an acid treatment in 12 wt. % H2SO4 at 60 °C for 24 h. This batch will herein after being called Invention 1.

For comparison, the fraction of the coated cutting tools not subjected to the acid treatment was divided into 3 batches, Comparative 1-3.

Invention 1 and Comparative 1-3 were subjected to a dry blasting treatment using an injection blasting system with manual movement of the blasting gun performed in a suction blasting cabinet “Boy 100” equipped with a filtration unit. The blasting media was with Al₂O₃ (mesh 120). The pressure was 5 Bar and the nozzle diameter was 8 mm and the nozzle distance was 70 mm. The blasting time was varied and can be seen in Table 1. The cutting tools were inspected visually, and the result is given in Table 1.

TABLE 1

| | Acid | Blasting time | Coating status after |
|---|---|---|---|
| | treatment | (sec) | blasting |
| Invention 1 | Yes | 60 | No coating |
| Comparative 1 | No | 25 | Coating still present |
| Comparative 2 | No | 70 | Coating still present |
| Comparative 3 | No | 120 | Coating still present |

As can be seen in the example is that the removal rate of the coating is not sufficient with only blasting, even if the blasting time longer, whereas the process according to the invention shows a high removal rate.

1. A method of removing residues and/or coating from cemented carbide scrap comprising the steps of:
subjecting the cemented carbide scrap to an acid treatment in an acid solution having a concentration of between 0.2 and 10 N, for a time period of between 30 minutes and 72 hours, and at a temperature of between 15 and 99 °C; and
removing the residues and/or coating by mechanical means.

2. The method according to claim 1, wherein the mechanical means are tumbling.

3. The method according to claim 1, wherein the mechanical means are blasting.

4. The method according to claim 1, wherein the acid solution has a concentration of between 0.3 and 6 N.

5. The method according to claim 1, wherein the acid is one or more of sulfuric acid (H₂SO₄), hydrochloric acid (HCl), acetic acid (CH₃COOH) phosphorus acid (H₃PO₃).

6. The method according to claim 1, wherein the acid is sulfuric acid (H₂SO₄).

7. The method according to claim 1, wherein the cemented carbide scrap is subjected to a mechanical pre-treatment prior to the acid treatment.

8. The method according to claim 7, where the mechanical pre-treatment is selected from tumbling, blasting and crushing.

9. The method according to claim 1, wherein the cemented carbide scrap is composed of cutting tools including a coating.

10. The method according to claim 9, wherein the coating is deposited by any of PVD (physical vapor deposition), CVD (chemical vapor deposition) or HIPIMS (high power impulse magnetron sputtering) which is a PVD technique.
